(19) United States
(12) Patent Application Publication
(10) Pub. No.: US 2025/0148720 A1
(43) Pub. Date: May 8, 2025

(54) GENERATION OF THREE-DIMENSIONAL MESHES OF VIRTUAL CHARACTERS

(71) Applicant: Roblox Corporation, San Mateo, CA (US)

(72) Inventors: Gordon Thomas FINNIGAN, Burlington (CA); Yueqian Zhang, San Mateo, CA (US); Hsueh-Ti Derek Liu, Burnaby (CA)

(73) Assignee: Roblox Corporation, San Mateo, CA (US)

(21) Appl. No.: 18/939,429

(22) Filed: Nov. 6, 2024

Related U.S. Application Data
(60) Provisional application No. 63/597,040, filed on Nov. 8, 2023.

(51) Int. Cl. G06T 17/20; G06T 13/40; G06T 15/04

(52) U.S. Cl. CPC G06T 17/205; G06T 13/40; G06T 15/04

(57) ABSTRACT

Implementations relate to methods, systems, and computer-readable media to automatically perform rigging of physics based three dimensional objects. In some implementations, the method may include obtaining a source three-dimensional (3D) mesh of a face of an avatar, wherein the source 3D mesh includes a first plurality of polygons, generating a second 3D mesh based on the source 3D mesh, wherein a count of polygons in the second 3D mesh is fewer than a count of polygons in the source 3D mesh, determining a two-dimensional (2D) parameterization of the second 3D mesh, determining a target 2D parameterization based on a template 3D mesh and the 2D parameterization of the second 3D mesh such that one or more landmarks identified in the source 3D mesh are aligned with corresponding landmarks on the template 3D mesh, and reconstructing the target 2D parameterization into a target 3D mesh.

### CROSS-REFERENCE TO RELATED APPLICATIONS

This application claims priority to U.S. Provisional Application No. 63/597,040, entitled “QUAD TEMPLATE FITTING FOR MESH RETOPOLOGY AND RIGGING,” filed on Nov. 8, 2023, the content of which is incorporated herein in its entirety.

### TECHNICAL FIELD

Embodiments relate generally to computer-based virtual experiences and computer graphics, and more particularly, to methods, systems, and computer readable media to automatically generate three-dimensional (3D) meshes for virtual characters that are displayed and animated on computing devices.

### BACKGROUND

Some online virtual experience platforms allow users to connect with each other, interact with each other (e.g., within a virtual experience), create virtual experiences, and share information with each other via the Internet. Users of online virtual experience platforms may participate in multiplayer environments (e.g., in virtual three-dimensional environments), design custom environments, design characters, three-dimensional (3D) objects, and avatars, decorate avatars, and exchange virtual items/objects with other users.

One of the challenges in computer graphics is the animation of virtual characters (or avatars) in virtual environments. Animation of a virtual character is commonly implemented via deformations of vertices of a 3D mesh of the virtual character. Content creators (developers) may start with a 3D mesh of a virtual character created or designed according to a particular intent. In some scenarios, the 3D mesh may be generated automatically by utilizing a generative machine learning (ML) technique. The 3D mesh, however, may have poor topology and may be unsuited for accurate, performant, and realistic animation of the virtual character.

A challenge in computer graphics and virtual experience (e.g., game) design, is the process of rigging a 3D mesh of a virtual avatar, particularly of the faces of virtual avatars. In many scenarios, content creators (developers) may start with a 3D mesh of a virtual character (avatar) that accurately represents the surface features of the virtual avatar, e.g., outer geometry of the virtual avatar, texture (e.g., complexion) of the virtual avatar, etc. However, the 3D mesh may have poor topology and may lead to poor animation within a virtual experience.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform a computer-implemented method that includes obtaining a source three-dimensional (3D) mesh of a face of an avatar, wherein the source 3D mesh includes a first plurality of polygons, generating a second 3D mesh based on the source 3D mesh, wherein a count of polygons in the second 3D mesh is fewer than a count of polygons in the source 3D mesh, determining a two-dimensional (2D) parameterization of the second 3D mesh, determining a target 2D parameterization based on a template 3D mesh and the 2D parameterization of the second 3D mesh such that one or more landmarks identified in the source 3D mesh are aligned with corresponding landmarks on the template 3D mesh, and reconstructing the target 2D parameterization into a target 3D mesh.

In some implementations, generating the second 3D mesh may include obtaining a trimmed 3D mesh by excluding particular portions of the source 3D mesh. In some implementations, the particular portions of the source 3D mesh are one or more of: portions of the source 3D mesh that correspond to hair of the face, portions of the source 3D mesh where an angle of a normal at the portions meets a threshold angle, portions of the source 3D mesh that lie at least a threshold distance from the one or more landmarks identified in the source 3D mesh, and combinations thereof.

In some implementations, the computer-implemented method may further include prior to determining the target 2D parameterization based on the template 3D mesh, obtaining a trimmed template 3D mesh by excluding portions in the template 3D mesh that meet predetermined criteria, and wherein determining the target 2D parameterization is based on the trimmed template 3D mesh.

In some implementations, the computer-implemented method may further include filling in the particular portions of the target 3D mesh by performing a constrained fit such that every point included in the target 3D mesh is exactly constrained and points corresponding to the particular portions are deformed from the template 3D mesh.

In some implementations, the computer-implemented method may further include determining the target 2D parameterization of the template 3D mesh comprises applying a least squares conformal map (LSCM) technique to points of the template 3D mesh that lie outside the particular portions of the source 3D mesh. In some implementations, determining the 2D parameterization of the second 3D mesh comprises applying a least squares conformal map (LSCM) technique to the second 3D mesh.

In some implementations, the one or more landmarks identified in the source 3D mesh correspond to one or more of eyes, nose, and mouth. In some implementations, the computer-implemented method may further include simulating motion of parts of the face by simulating motion of points in the target 3D mesh that correspond to the parts of the face.

In some implementations, the computer-implemented method may further include generating an image of the face based on the target 3D mesh by transferring one or more of a UV texture map, skinning, and animation routine from the template 3D mesh to the target 3D mesh.

One general aspect includes a non-transitory computer-readable medium with instructions stored thereon that when executed, performs operations that include obtaining a source three-dimensional (3D) mesh of a face of an avatar, wherein the source 3D mesh includes a first plurality of polygons, generating a second 3D mesh based on the source 3D mesh, wherein a count of polygons in the second 3D mesh is fewer than a count of polygons in the source 3D mesh, determining a two-dimensional (2D) parameterization of the second 3D mesh, determining a target 2D parameterization based on a template 3D mesh and the 2D parameterization of the second 3D mesh such that one or more landmarks identified in the source 3D mesh are aligned with corresponding landmarks on the template 3D mesh, and reconstructing the target 2D parameterization into a target 3D mesh.

One general aspect includes a system that includes a memory with instructions stored thereon; and a processing device coupled to the memory, the processing device configured to access the memory and execute the instructions, where the execution of the instructions cause the processing device to perform operations that may include obtaining a source three-dimensional (3D) mesh of a face of an avatar, wherein the source 3D mesh includes a first plurality of polygons, generating a second 3D mesh based on the source 3D mesh, wherein a count of polygons in the second 3D mesh is fewer than a count of polygons in the source 3D mesh, determining a two-dimensional (2D) parameterization of the second 3D mesh, determining a target 2D parameterization based on a template 3D mesh and the 2D parameterization of the second 3D mesh such that one or more landmarks identified in the source 3D mesh are aligned with corresponding landmarks on the template 3D mesh, and reconstructing the target 2D parameterization into a target 3D mesh.

### BRIEF DESCRIPTION OF THE DRAWINGS

FIG. 1 is a diagram of an example environment to generate three-dimensional (3D) meshes of faces, in accordance with some implementations.

FIG. 2 depicts an example 3D mesh of a virtual character, in accordance with some implementations.

FIG. 3 is a schematic that depicts an example of an end-to-end workflow to generate three-dimensional (3D) meshes of virtual characters, in accordance with some implementations.

FIG. 4 illustrates an example method to generate a three-dimensional (3D) mesh of a virtual character based on a template 3D mesh and a source 3D mesh of a virtual character, in accordance with some implementations.

FIG. 5 illustrates an example of a source 3D mesh and a second 3D mesh with a fewer number of polygons obtained by converting the source 3D mesh, in accordance with some implementations.

FIG. 6 depicts an example of exclusion of particular portions of a 3D mesh of a virtual character to determine a trimmed 3D mesh of the face, in accordance with some implementations.

FIG. 7 depicts an example of a 2D parameterization of a trimmed 3D mesh of a virtual character, in accordance with some implementations.

FIG. 8 depicts an example of a template 3D mesh of a virtual character trimmed to exclude selected portions of the face, in accordance with some implementations.

FIG. 9 depicts an example overlay of a 2D parameterized mesh of a virtual character and a corresponding 2D parameterization of a template 3D mesh, in accordance with some implementations.

FIG. 10 depicts an example reinflation of a 2D parameterized mesh into a target 3D mesh of a virtual character, in accordance with some implementations.

FIG. 11 depicts an example of constrained fitting of excluded portions of a face in a target 3D mesh of a virtual character, in accordance with some implementations.

FIG. 12 depicts example images of an animated face in a virtual environment, in accordance with some implementations.

FIG. 13 illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

Online virtual experience platforms (also referred to as user-generated content platforms or user-generated content systems) offer a variety of ways for users to interact with one another. For example, users of an online virtual experience platform may work together towards a common goal, share various virtual experience items, send electronic messages to one another, and so forth. Users of an online virtual experience platform may join virtual experience(s), e.g., games or other experiences as virtual characters, playing specific roles. For example, a virtual character may be part of a team or multiplayer environment wherein each character is assigned a certain role and has associated parameters, e.g., clothing, armor, weaponry, skills, etc. that correspond to the role. In another example, a virtual character may be joined by computer-generated characters, e.g., when a single player is part of a game.

A virtual experience platform may enable users (developers) of the platform to create objects, new games, and/or characters. For example, users of the online gaming platform may be enabled to create, design, and/or customize new characters (avatars), new animation packages, new three-dimensional objects, etc. and make them available to other users.

On some virtual platforms, developer users may generate and/or upload three-dimensional (3D) object models, e.g., meshes and/or textures of 3D objects, for use in a virtual experience and for trade, barter, or sale on an online marketplace. The models may be utilized and/or modified by other users. The model can include 3D meshes that represent the geometry of the object and include vertices, and define edges, and faces. The model may additionally include UV maps and/or textures that define properties of the object surface.

A virtual experience platform may also allow users of the platform to create and animate new characters and avatars. For example, users of the virtual experience platform may be enabled to create, design, customize, and animate new characters.

In some implementations, animation may include characters that move one or more body parts to simulate movement such as walking, running, jumping, dancing, fighting, wielding a weapon such as a sword, etc. In some implementations, avatars may generate facial expressions, where a part of a body, e.g., a face, is depicted in motion. In some scenarios, movement of the entire body of the character may be depicted. Animations may correspond to various movements, e.g. graceful, warrior-like, balletic, etc.

In some implementations, animation of virtual characters (avatars) may include animation of one or more portions of a face of a virtual character. For example, a smile of a virtual character in a virtual environment may be depicted by adjusting vertices of a mesh that corresponds to the mouth and/or other parts of the face of the virtual character, Similarly, animation of an avatar's face may be performed to depict an avatar speaking; adjustment of the eye(s) may be utilized to depict eye movements of a virtual character during a dance sequence. In some implementations, animation of the face may be performed to depict facial expressions of virtual characters associated with certain emotions of a virtual character. For example, animation of an avatar of a user participating in a virtual experience may be depicted to mirror speech and/or emotions of the user.

In some implementations, animation of a virtual character may be performed by rendering a sequence of images to create the illusion of motion of one or more parts of the virtual character. In some implementations, particular frames may be utilized to define the starting and ending points of an object or virtual character's motion in an animation. Interpolation between the particular frames may be performed to determine a sequence of frames (images) that may then be rendered, e.g., on a display device. In some implementations, each of the particular frames may include vertices of a 3D mesh of the virtual character.

For example, animation of a virtual character to depict a smile of the virtual character may be performed by translating vertices of the 3D mesh that correspond to the ends of the mouth in opposite directions by a specified amount. A narrow smile on the face may be depicted by translation of the vertices at the ends of the mouth by a first distance, while a broader smile may be depicted by translation of the vertices at the ends of the mouth by a second distance that is greater than the first distance.

In some implementations, a virtual experience platform may include support for animatable head models. The animatable head model may include an internal facial rig, or bone structure, that drives the deformation of the viewable geometry associated with the virtual character. The bone structure can include multiple bones that can be moved or deformed to enable various types of facial expressions.

In some implementations, developer users may store various bone deformations as individual poses. In some implementations, facial animation may be performed by combining the individual poses to create expressions and animations.

In some implementations, rigging of a virtual avatar may be performed which involves associating the geometry of a polygonal mesh or implicit surface to be driven by an underlying bone structure. This conveys the effect of deformation and/or motion of a 3D object based on the motion of the underlying bone structure.

Rigging of 3D objects such as characters (avatars) can utilize standardized rigs (skeletons), e.g., R6 based virtual characters (with 6 joints for an avatar body), R15 based virtual characters (with 15 joints for an avatar body), etc., that are fitted to a surface geometry of an avatar to provide an underlying structure. In some implementations, the rigging of the avatar may be automatically performed. An objective of rigging of avatars is to generate aesthetically pleasing geometric deformations of the avatar based on the motion of the skeleton.

In some implementations, animation routines from one virtual character may be usable for other virtual characters, e.g., when they share a common morphology. In some implementations, the virtual experience platform may provide a set of standardized animation routines for use on the platform. The animation routines may be utilized to animate virtual characters by moving relevant vertex positions of a 3D mesh of the virtual character.

In some implementations, an avatar rig may be specified to include certain controls, and the animations can animate the controls to drive the change in vertex positions of a 3D mesh. This can enable animations to be shared between models with different rigs.

The quality (e.g., smoothness, realism, etc.) of animation of a virtual character on a virtual experience platform depends on the quality of an underlying 3D mesh of the virtual character. The quality of a 3D mesh may be characterized by its topology. A 3D mesh commonly includes a plurality of polygons, e.g., triangles, quads, etc., that are connected to form the 3D mesh. In some implementations, the quads may be divided into triangles during rendering of the 3D mesh. Each vertex of the polygon is associated with a respective 3D coordinate.

Superior (good) topology is topology where the underlying mesh of the 3D object or virtual character is evenly distributed, with a higher mesh density in areas subject to higher deformation (movement), e.g., eyes, mouth, shoulders, elbows, etc. Additionally, realistic animation of a virtual character is enabled when the mesh vertices are aligned with muscle locations, and the mesh edges are aligned with muscle directions.

However, 3D meshes that are generated by developer users and/or by generative machine learning (ML) techniques may not have a good topology. For example, a 3D mesh of a virtual character may include mesh vertices and edges of a face of the virtual character that are misaligned with facial muscles. This can lead to unrealistic animation of the face of the virtual character and can contribute to poor user experience.

In some scenarios, a 3D mesh generated by a generative ML technique may include a relatively large (e.g., a number that exceeds a predetermined threshold) number of polygons. A large number of polygons leads to a higher computational processing requirement on a processor of a computing device where animation is performed. This may lead to a slowdown of the animation and/or bursty images, skipped frames, etc., due to the processor not being able to meet real-time processing requirements.

In some implementations, 3D meshes may be automatically generated from iso-surfaces, signed distance fields (SDFs), or other volumetric functions, whereby algorithms such as marching cubes may be utilized to generate 3D meshes based on prompts received from users.

In some other implementations, 3D meshes may be generated based on application of a neural radiance field (NeRF) technique. The NeRF technique may utilize a deep learning model to reconstruct a three-dimensional representation of a scene or virtual avatar from two-dimensional images.

In some scenarios, the 3D meshes generated by the above-mentioned techniques, e.g., ML based 3D mesh generation, NeRF based mesh generation, etc., are not well suited for animation in a real-time environment. This is because the 3D meshes may be high-resolution, e.g., include too many vertices and polygons and/or have other unsuitable topology, e.g., too many sliver triangles (a triangle whose area is so thin that the interior of the triangle does not contain a distinct span for each scan line). In some cases, the 3D meshes may include edges that are not aligned to the target deformation(s) in the animation. In some scenarios, the 3D meshes may include noise and/or other artifacts due to the techniques utilized to generate the 3D mesh.

In some implementations, an unsuitable 3D mesh may be retopologized to generate a 3D mesh with a new topology with more suitable characteristics for animation.

In some implementations, an Iterative Closest Point (ICP) registration technique may be applied to a 3D mesh with poor topology in conjunction with a template 3D mesh with good topology. The ICP technique is applied to minimize a distance between corresponding cloud points so that a source cloud point (a received 3D mesh with poor topology) and target cloud point (a template 3D mesh with good topology) converge. Applying an ICP technique may enable generation of a slightly deformed version of the template 3D mesh but may not fully capture the geometry shape of the original 3D mesh. Additionally, projection of the resultant 3D mesh to the original input surface leads to bunching of the projected points around concave areas.

A technical objective in rigging of virtual avatars is to generate 3D meshes with good topology and to suitably adjust pre-existing 3D meshes that have poor topology to a good topology, such that the virtual avatar can be animated in a satisfactory manner, e.g., in (near) real-time, with smooth and realistic motion, etc.

For example, the 3D mesh of a virtual character may have a relatively large number of polygons that can lead to frozen frames during animation due to a high computational load on a computing device. In some scenarios, rendered images during the animation may be unrealistic due to the edges of the 3D mesh being misaligned with natural facial muscles of a virtual character.

Per techniques of this disclosure, 3D meshes of virtual avatars with good topology can be automatically generated from 3D meshes that have poor topology. In some implementations, pre-generated template 3D meshes of virtual characters are utilized to suitably adjust the 3D mesh of a virtual avatar to generate a target 3D mesh of the virtual avatar such that the target 3D mesh has the topology of the template 3D mesh but matches the geometry of the source (input) 3D mesh.

In addition to the input 3D mesh of a virtual avatar and a template 3D mesh with topology suitable for animation, a mapping of corresponding landmarks between the input 3D mesh and the template 3D mesh is obtained.

In some implementations, a set of positions in the input 3D mesh that are to be ignored is also obtained. The set of positions may include detected landmark outliers in the fitting, landmarks which have been detected as being located behind certain portions of the mesh. A landmark may be determined to be a landmark outlier if it lies at an unexpected distance from its neighbors. For example, this may occur due to a hole in the mesh, a shallow angle that yields unstable results (e.g., where a small change in the 2D landmark image position results in a large change in the 3D mesh), or if the landmark algorithm performs poorly on a given input.

For example, if an eye of a virtual avatar is partially covered by hair, any landmark of the eye that lands on a hair portion of the mesh may be deemed unreliable, and not used for the fitting.

Per techniques of this disclosure, the input 3D mesh is retopologized to generate a second 3D mesh that includes a reduced number of polygons when compared to the input 3D mesh. In some implementations, selected portions in the second 3D mesh may be excluded, e.g., points on the 3D mesh that are facing away from the viewing angle, hair, etc., to generate a trimmed 3D mesh. Depending on the implementation, a two-dimensional (2D) parameterization of the second 3D mesh is determined by flattening the trimmed 3D mesh or the second 3D mesh.

Similar operations (to those performed on the input 3D mesh) are performed on a template 3D mesh. Selected portions in the template 3D mesh are excluded. A target 2D parameterization of the template 3D mesh is generated such that landmarks identified in the source 3D mesh are aligned with corresponding landmarks on the template 3D mesh. The target 2D parameterization is reconstructed (inflated) into a target 3D mesh.

Portions that were excluded from the source 3D mesh may be fitted back to the target 3D mesh by performing a normal-regularized-as-conformal-as-possible (NACAP) fitting. Other disconnected features (parts) of the virtual avatar may be generated by performing a radial basis function (RBF) deformation of the disconnected parts.

An objective of a virtual experience platform owner or administrator is the provision of realistic depiction of virtual characters, and particularly accurate depiction of the motion and/or facial expressions of the virtual characters. An additional objective of the virtual experience platform owner or administrator is to provide tools to content creators that can enable them to perform rigging of virtual characters (avatars).

A technical problem for operators and/or administrators of virtual experience platforms is the provision of automatic, accurate, scalable, cost-effective, and reliable tools for creation (generation) and editing of 3D meshes of virtual characters that have good topology.

An additional technical problem is to enable generation of other aspects, e.g., UV mapping, rigging, and animation, etc., of the 3D mesh of a virtual character in order to prepare it for animation in a real-time environment.

Techniques described herein may be utilized to provide a scalable and adaptive technical solution for the physical rigging of 3D objects. Various implementations described herein address the above-described drawbacks by providing techniques for the generation of 3D meshes with good topological properties.

In some implementations, the techniques may be utilized within a tool, e.g., a studio tool that may be utilized by developers to rig mesh assets that have been generated based on descriptions, e.g., textual prompts, voice prompts, sketches, etc. In some implementations, the tool may support creators to create virtual characters, e.g., for virtual characters where the 3D models (e.g., 3D meshes) have been created by the user, virtual characters (3D meshes) provided via the virtual experience platform, 3D meshes of virtual characters generation via the application of generative machine learning (ML) techniques, 3D meshes of virtual characters obtained or purchased from other users, etc.

In some implementations, the techniques described herein may be utilized by a virtual platform to enable users to modify properties of a virtual character, during their participation in a virtual experience, thereby enabling creators and players to customize 3D objects based on their preferences. This could enable in-experience creation wherein users (e.g., non-developer users) can utilize the techniques to customize their virtual characters for their virtual experience. Techniques described herein may enable use templatized topologies wherein rigs and animations may be transferred from one 3D model to another, thereby enabling efficient generation of animatable virtual characters.

Techniques for mesh rigging described herein introduce a new approach to the generation of animation ready virtual characters that can enable users to create a wide variety of virtual characters. The automated processes contribute to more efficient and accessible 3D mesh customization, promoting creativity and enabling a wider range of users to create virtual characters with ease.

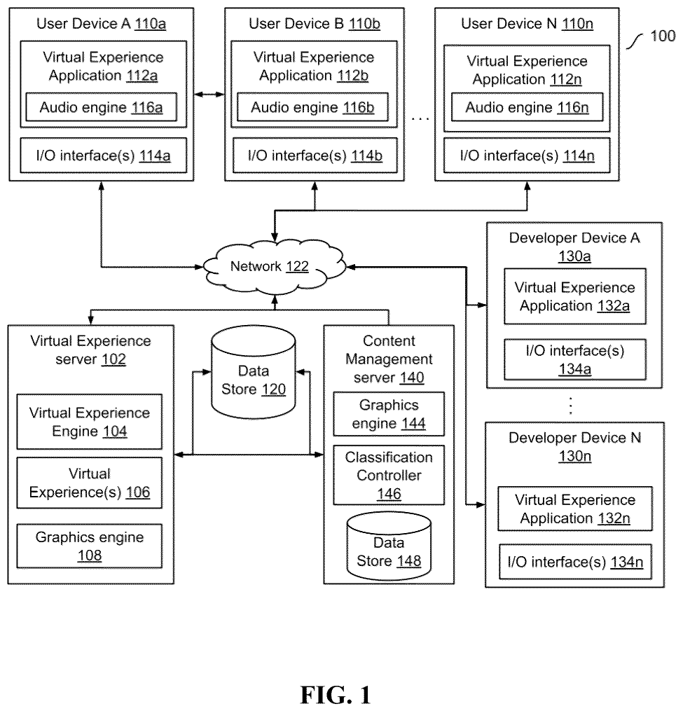

FIG. 1 is a diagram of an example environment to generate three-dimensional (3D) meshes of virtual characters, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, user devices 110a, 110b, and 110n (generally referred to as “user device(s) 110” herein), and developer devices 130a and 130n (generally referred to as “developer device(s) 130” herein), virtual experience server 102, content management server 140, data store 120, user devices 110, and developer devices 130 are coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience (e.g., a game) 106 may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or user devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of an unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g. games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes.

Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device. In some implementations, audio engine 116 may act cooperatively with audio engine 144 that is installed on the sound server.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs), and thus is not limited to use in websites.

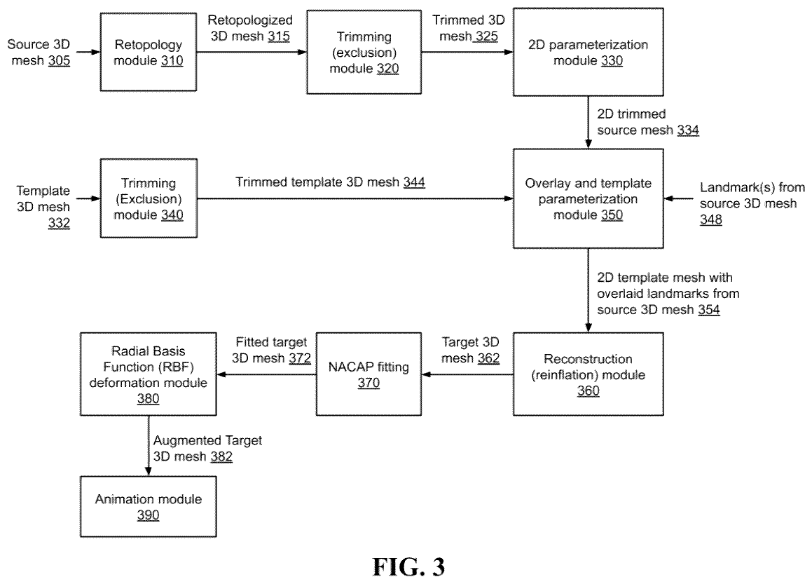

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below in connection with the flowcharts and workflows shown in FIG. 3.

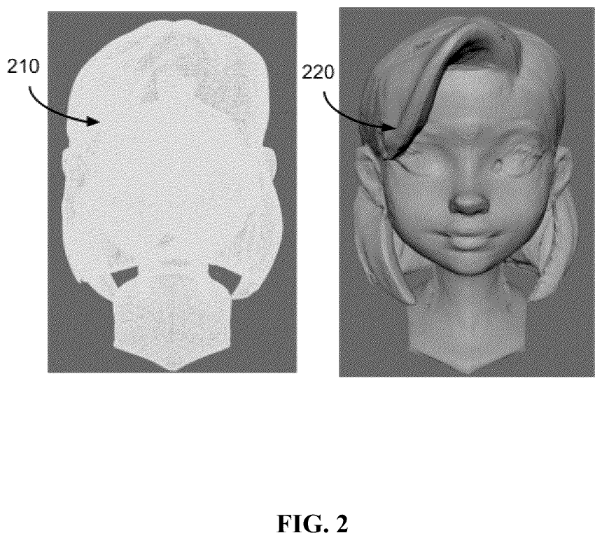

FIG. 2 depicts an example 3D mesh of a virtual character, in accordance with some implementations. A source 3D mesh 210 and a corresponding solid body representation 220 of the source 3D mesh are illustrated. Textures may be optionally added via a UV map to create a virtual character (not shown in FIG. 2).

In this illustrative example, the source 3D mesh is obtained by application of a generative machine learning model and generated from isosurfaces that have been meshed using a marching cubes technique. As can be seen in FIG. 2, the source 3D mesh includes sufficient details of the virtual character but has a poor topology for use in a graphics engine due to a large number of polygons, and edges of the mesh that are not aligned to the natural movement of a face.

FIG. 3 is a schematic that depicts an example of an end-to-end workflow to generate three-dimensional (3D) meshes of virtual characters, in accordance with some implementations.

As illustrated in FIG. 3, the workflow includes providing a source 3D mesh of a virtual character 305 to a retopology module 310. The retopology module generates a retopologized 3D mesh of the virtual character 315, which is provided to a trimming (exclusion) module 320.

A trimmed 3D mesh 325 generated by trimming (exclusion) module 320 is provided to a 2D parameterization module 330 to transform the trimmed 3D mesh 325 into a 2D representation—a 2D trimmed source mesh 334. The 2D trimmed source mesh 334 is provided to an overlay and template parameterization module 350. Landmark(s) from the source 3D mesh 348 are also provided to the overlay and template parameterization module 350.

A template 3D mesh 332 is retrieved, e.g., from a storage device on a virtual experience platform. A trimming module 340 is utilized to trim the template 3D mesh 332 and generate a trimmed template 3D mesh 344. The trimmed template 3D mesh 344 is provided to overlay and template parameterization module 350.

A 2D template mesh 354 (a target 3D parameterization of the template 3D mesh) that includes overlaid landmarks from the source 3D mesh is generated by the overlay and template parameterization module 350 by aligning particular landmarks from the source 3D mesh to the trimmed template 3D mesh 344.

The target 3D parameterization of the template 3D mesh 354 is provided to a reconstruction module 360 that generates a target 3D mesh 362.

A NACAP fitting module 370 operates on the target 3D mesh 362 to generate a fitted target mesh 372 that includes the portions of the template 3D mesh 332 that were excluded (trimmed) by trimming module 340.

The fitted target 3D mesh 372 is provided to a radial basis function (RBF) deformation module 380 to determine an augmented target 3D mesh 382 that may include other attached features, e.g., eyeballs, ears, etc. The augmented target 3D mesh 382 may be provided to an animation module 390 and utilized to generate animation for the virtual character.

In some implementations, or more of the blocks described herein may be omitted, and additional operations performed. For example, retopology may be optional if a particular source mesh has a low number of polygons to begin with. Trimming may not be performed in some implementations. In some implementations, other forms of fitting may be utilized instead of NACAP fitting, deformation can be performed using techniques other than RBF, etc.

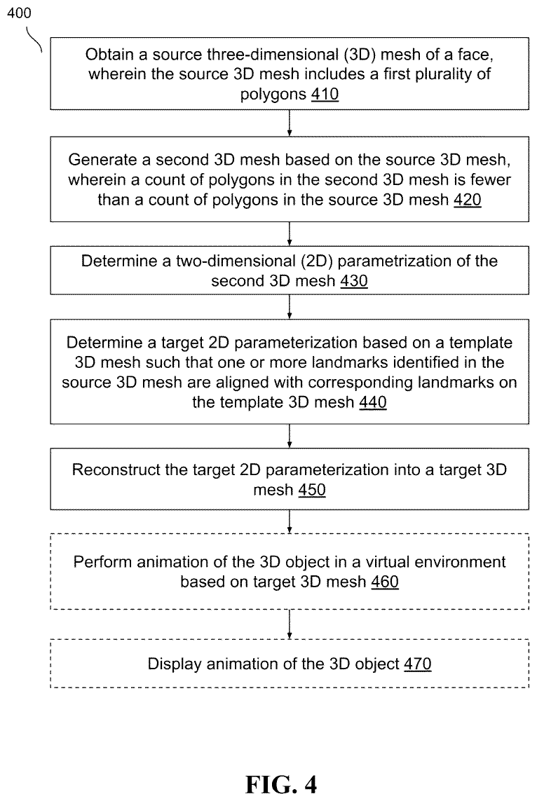

FIG. 4 illustrates an example method to generate a three-dimensional (3D) mesh of a virtual character based on a template 3D mesh and a source 3D mesh of a virtual character, in accordance with some implementations.

In some implementations, method 400 can be implemented, for example, on virtual experience 102 described with reference to FIG. 1. In some implementations, some or all portions of the method 300 can be implemented on one or more client devices 110 as shown in FIG. 1, on one or more developer devices 130, or on one or more server device(s) 102, and/or on a combination of developer device(s), server device(s), and client device(s). In described examples, the implementing system includes one or more digital processors or processing circuitry (“processors”), and one or more storage devices (e.g., a database 120 or other storage). In some implementations, different components of one or more servers and/or clients can perform different blocks or other parts of the method 400. In some examples, a first device is described as performing blocks of method 400. Some implementations can have one or more blocks of method 400 performed by one or more other devices (e.g., other client devices or server devices) that can send results or data to the first device.

In some implementations, method 400, or portions of the method, can be initiated automatically by a system. In some implementations, the implementing system is a first device. For example, the method (or portions thereof) can be periodically performed, or performed based on one or more particular events or conditions, e.g., a request received from a user to generate a mesh of a virtual character, a request received from a user to generate an animation of a virtual character, receiving a 3D mesh of a virtual character at the virtual experience platform, a predetermined time period having expired since the last performance of method 400, and/or one or more other conditions occurring which can be specified in settings read by the method.

Method 400 may begin at block 410.

At block 410, a source three-dimensional (3D) mesh of a virtual avatar is obtained. In some implementations, the 3D mesh is a representation (e.g., a mathematical model) of the geometry of the virtual avatar. In some implementations, the 3D mesh may also define one or more surfaces of the virtual avatar. In some implementations, the virtual avatar may be a human, a humanoid, a robot, an animal, or an imaginary character. In some implementations, the virtual avatar may be the face of a virtual avatar, and may include one or more features of a face, e.g., nose, eyes, mouth, hair, etc.

In some implementations, the source 3D mesh may include a first plurality of polygons. In some implementations, the polygons may include triangles that are defined by three vertices and three edges, by quads that are defined by four edges (sides) and four vertices, and/or by other polygons.

In some implementations, the 3D mesh may be generated (or have been already generated) by applying a generative machine learning (gen-ML) model, e.g., a generative adversarial network (GAN) model, to a user provided prompt, e.g., a text prompt, a voice prompt, a sketch, etc., that specifies elements of a virtual avatar. Tools provided by the virtual experience platform may enable users to apply the gen-ML techniques to generate 3D meshes of virtual avatars based on provided descriptions.

In some implementations, the virtual experience platform may enable users to submit (upload) 3D meshes of the virtual platform for utilization on the platform. A virtual experience development environment (developer tool) may be provided by the platform, in accordance with some implementations. In some implementations, the 3D mesh may be received (imported) in a FBX file format. The mesh file may include data that provides dimensional data about polygons that comprise the virtual avatar and UV map data that describes how to attach portions of texture to various polygons that comprise the 3D object.

Block 410 may be followed by block 420.

At block 420, a second 3D mesh may be generated based on the source 3D mesh. In some implementations, a count of polygons in the second 3D mesh may be fewer than a count of polygons in the source 3D mesh. In some implementations, the second 3D mesh may be generated by applying a retopologizing technique to the source 3D mesh.

In some implementations, vertices and edges in the source 3D mesh may be adjusted (optimized) during the retopologizing such that the second 3D mesh may be as uniform as possible (e.g., where the second 3D mesh is more isotropic than the source 3D mesh) and include triangles that approximate equilateral triangles of equal size. Additionally, in some implementations, the retopologizing may include aligning and snapping edges present in the source 3D mesh to features included in the virtual avatar.

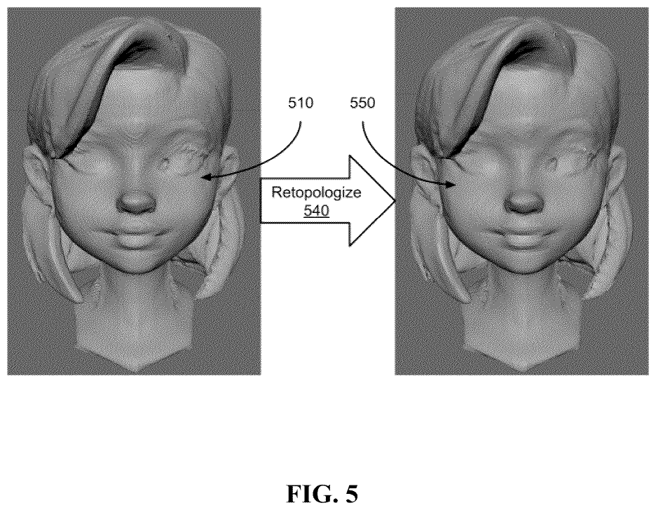

FIG. 5 illustrates an example of a source 3D mesh and a second 3D mesh with a fewer number of polygons obtained by converting the source 3D mesh, in accordance with some implementations.

FIG. 5 depicts source 3D mesh 510 that is retopologized (540) to a second 3D mesh 550. In this illustrative example, a number of polygons in the 3D mesh is reduced from an order of about a million polygons to about 40,000 polygons. Additionally, a number of faces (closed polygons in the 3D mesh) in the second 3D mesh is also fewer than a number of faces in the source 3D mesh.

In some implementations, retopologizing may also include generating better-formed triangles, e.g., by reducing a number of sliver triangles that can cause numerical stability issues in a solver.

In some implementations, generating the second 3D mesh may further include obtaining a trimmed 3D mesh as the second 3D mesh by excluding selected portions of the source 3D mesh. For example, in some implementations, selected portions of the 3D mesh that meet a predetermined criteria may be excluded during generation of the second 3D mesh. In some implementations, the excluded portions may include portions where the portions are not front facing, e.g., where a normal at the surface of the portion of the 3D mesh is pointed away from a viewing angle of a camera positioned in the virtual experience.

In some implementations, the selected portions of the source 3D mesh that may be excluded can include one or more of portions of the source 3D mesh that correspond to hair on a face of the virtual avatar, portions of the source 3D mesh where an angle of a normal at the portions meets a threshold angle, and portions of the source 3D mesh that lie a threshold distance from the one or more landmarks identified in the source 3D mesh.

In some implementations, the landmarks may include specified landmarks on a face of the virtual avatar. For example, the specified landmarks may include eyes, nose, mouth, forehead, etc. In some implementations, the specified landmarks may additionally include ears of a virtual character.

In some implementations, detection of the position(s) of hair of the virtual character may be performed by applying a segmentation technique to the source 3D mesh. In some implementations, the segmentation is performed on a rendered 2D image, and projected to the 3D mesh. In some other implementations, the position(s) of the hair of the virtual character may be specified by a label associated with the 3D mesh of the virtual avatar.

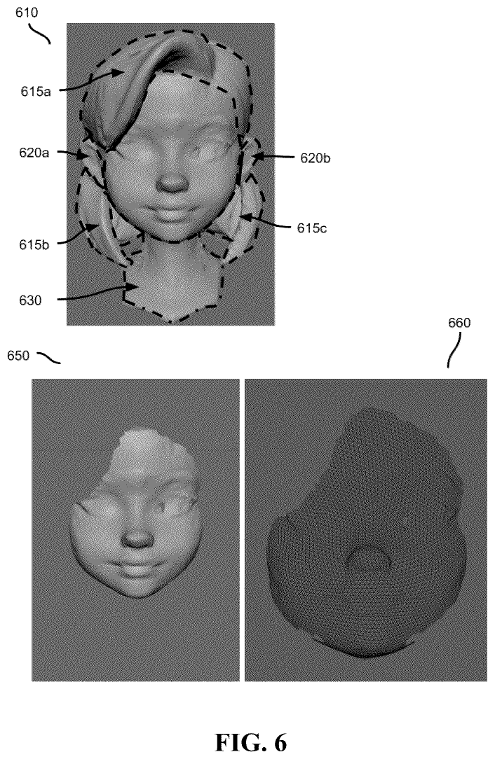

FIG. 6 depicts an example of exclusion of particular portions of a 3D mesh of a virtual character to determine a trimmed 3D mesh of the virtual character, in accordance with some implementations.

FIG. 6 depicts a 3D mesh (e.g., a 3D mesh of a virtual avatar after it has been retopologized) 610 and a trimmed 3D mesh of the virtual character 650, as well as the trimmed 3D mesh of the virtual character that includes the edges 660.

As depicted in FIG. 6, portions corresponding to hair (615a, 615b, and 615c), the ears (620a and 620b), and the neck 630 are excluded from the 3D mesh to generate the trimmed 3D mesh 650 and edge-included trimmed 3D mesh 660. In some implementations, exclusion of the portions of the 3D mesh may include excluding vertices (3D coordinates) associated with the excluded portions from the second 3D mesh. In some implementations, all specified landmarks on a face are included in the trimmed 3D mesh and not considered for exclusion.

In some implementations, a flood fill technique may be applied starting at the nose of the virtual avatar, and encountered vertices are included in the trimmed 3D mesh until a vertex obscured by hair, a vertex where the normal is pointing away from the front, or a vertex that meets a threshold distance from landmarks in the face of the virtual character is encountered. In some implementations, a largest connected component to the trimmed 3D mesh is additionally identified by the flood fill process. Block 420 may be followed by block 430.

At block 430, a two-dimensional (2D) parameterization of the second 3D mesh may be determined. In some implementations, determining the 2D parameterization of the second 3D mesh may include applying a least squares conformal map (LSCM) technique to the second 3D mesh.

In some implementations, applying a LSCM technique may include providing as input a 3D surface mesh (as represented by its vertices and faces) to an LSCM module that generates as output a 2D parameterization (e.g., UV coordinates) of the 3D surface. The 2D parameterization is obtained by minimizing a distortion in the mapping from the 3D domain to the 2D domain while preserving angles locally, essentially creating a flattened representation of the 3D shape with minimal area distortion.

In some implementations, applying a LSCM technique may include solving a system of linear equations that minimizes the sum of squared errors between a desired angle preservation (between respective edges and/or line segments) and the actual angle changes under the mapping, effectively determining a best fit conformal transformation based on the least squares principle.

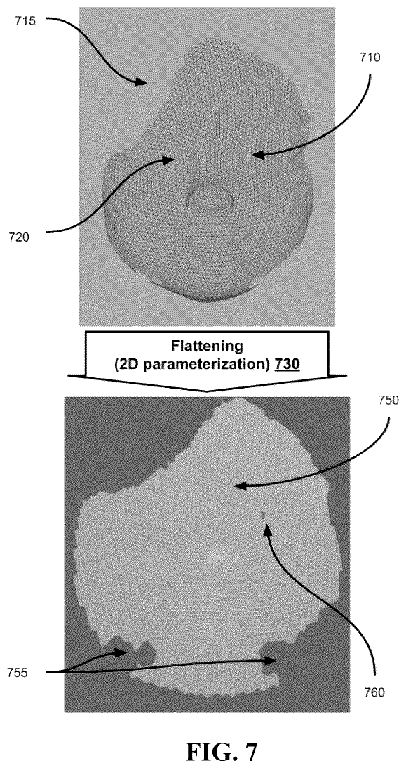

FIG. 7 depicts an example of a 2D parameterization of a trimmed 3D mesh of a virtual character, in accordance with some implementations.

FIG. 7 depicts an example second 3D mesh (subsequent to a trimming operation) 710 of a virtual character and a corresponding 2D parameterization 750. In this illustrative example, the excluded portion 715 in the second 3D mesh corresponds to portion 755 in the 2D parameterization 750, and a speck in the eye of a virtual character 720 corresponds to portion 760 in the 2D parameterization 750.

Operations similar to those performed on the source 3D mesh are also performed on a template 3D mesh. One or more template 3D meshes may be created and stored on the virtual experience platform. They may be authored by humans or may be machine generated. One or more template 3D meshes may be generated based on commonly utilized characters. In some implementations, a plurality of template 3D meshes corresponding to different types of virtual characters may be generated. The template 3D meshes are generated such that they have good topological properties.

In some implementations, good topological properties may include having a relatively low number of polygons, having a geometry with as few polygons as necessary to accurately represent the geometry of the virtual character and excluding unnecessary details in areas that don't require it. Additionally, the template 3D mesh may include an evenly distributed geometry that maintains a suitable polygon density (e.g., a threshold polygon density) across the template 3D mesh to capture desired details and ensure smooth deformations during animation, consistent normals to avoid shading problems and other issues, edges aligned with muscle groups for natural deformation during animation, and/or a sufficient number of quads that enable more predictable deformations when compared to triangles.

In some implementations, a suitable template 3D mesh may be selected from a plurality of template 3D meshes. In some implementations, the selection may be made based on a type of the source 3D mesh such that the template 3D mesh matches the type of the source 3D mesh. the type of the source 3D mesh may be determined by applying a machine learning (ML) model, based on descriptors provided by a user, or by attempting to fit with multiple meshes and finding the best fit as measured by various metrics, etc.

Subsequent to the selection of the suitable template 3D mesh, portions of the template 3D mesh may be excluded (trimmed) based on predetermined criteria. The predetermined criteria for exclusion may be similar to those utilized to trim the second 3D mesh of a virtual character.

For example, portions of the template 3D mesh that may be excluded can include one or more of portions of the template 3D mesh that correspond to hair on a face of the virtual avatar, portions of the template 3D mesh where an angle of a normal at the portions meets a threshold angle, and portions of the template 3D mesh that lie a threshold distance from the one or more landmarks identified in the template 3D mesh.

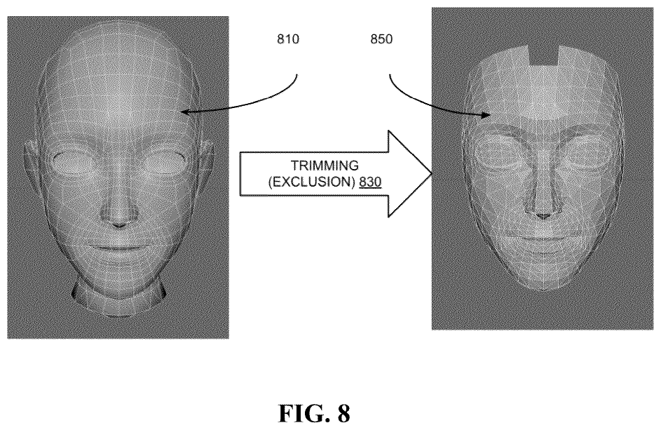

FIG. 8 depicts an example of a template 3D mesh of a virtual character trimmed to exclude selected portions of the face, in accordance with some implementations.

As depicted in FIG. 8, a template 3D mesh 810 is converted to a trimmed template 3D mesh 850 by performing an exclusion (trimming) 830 operation. Block 430 may be followed by block 440.

At block 440, a target 2D parameterization based on a template 3D mesh is determined. In some implementations, the target 2D parameterization is determined such that one or more landmarks identified in the source 3D mesh are aligned with corresponding landmarks in the (trimmed) template 3D mesh.

In some implementations, the one or more landmarks identified in the source 3D mesh include one or more of eyes, nose, and mouth of a virtual character. In some implementations, a position of vertices associated with the landmarks (e.g., position of vertices associated with the outer boundaries of the landmarks) may be determined by performing a segmentation operation on the 3D mesh.

In some other implementations, a position of vertices associated with the landmarks may be obtained from labels associated with the source 3D mesh. For example, the position of vertices associated with the landmarks may be obtained as an output of an ML model that is utilized to generate the source 3D mesh.

A technical advantage of matching the position(s) of corresponding landmarks between the trimmed second 3D mesh of the virtual avatar and the trimmed template 3D mesh of a virtual avatar in a 2D domain when compared to a 3D domain is that performing the 2D parameterization avoids bunching of vertices of the 3D mesh near concavities in the 3D mesh and is computationally more efficient.

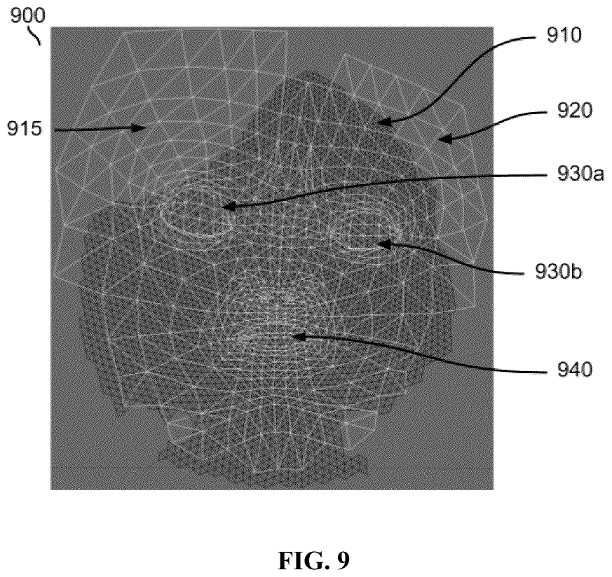

FIG. 9 depicts an example overlay of a 2D parameterized mesh of a virtual character and a corresponding 2D parameterization of a template 3D mesh, in accordance with some implementations.

As depicted in FIG. 9, a target 2D parameterization of the template mesh 910 compatible with the source 3D mesh is determined based on the position(s) of one or landmarks that correspond between the source 3D mesh and the template 3D mesh. Overlay 900 additionally depicts areas of the flattened template 3D mesh that do not overlap (e.g., portion denoted by areas 915 and 920) the flattened source 3D mesh, e.g., where portions in the source 3D mesh that correspond to hair of the virtual avatar was excluded.

In this illustrative example, depicted landmarks that are overlaid include eyes 930 and the mouth 940.

In some implementations, determining the target 2D parameterization of the template 3D mesh may include applying a LSCM technique to points in the template 3D mesh that lie outside vertices corresponding to the landmarks of the source 3D mesh while points in the template 3D mesh that correspond to the landmarks of the source 3D mesh are constrained during the flattening to the specified positions of the landmarks. Block 440 may be followed by block 450.

At block 450, the target 2D parameterization is reconstructed (reinflated) into a target 3D mesh that is usable to perform an animation of the virtual avatar.

Subsequent to determining a compatible 2D parameterization of the template 3D mesh, positions of vertices in the 2D parameterization of the template 3D mesh are transformed to their corresponding 3D positions. The target 3D mesh thus generated has a topology similar to that of a template 3D mesh, but matches the positions of the vertices in the source 3D mesh, particularly for portions of the template 3D mesh where there is correspondence with the source 3D mesh. The target 3D mesh includes vertices (3D coordinates) that are different from the template 3D mesh.

In some implementations, the reinflation may utilize barycentric coordinates. The reinflation operates on vertices where the 2D parameterization of the vertex of the template mesh is located within a 2D triangle of the parameterization of the input mesh. The barycentric coordinate of the 2D vertex of the template mesh is then computed with respect to that 2D triangle. The 3D position of that template vertex can be computed by evaluating the barycentric coordinate on the corresponding triangle in the 3D input mesh.

For example, consider a scenario that includes a 2D input mesh and a 2D template. An objective is to compute the vertex positions of the 3D template, for the vertices that match, based a 3D input mesh.

In such a scenario, for every vertex in the template, it is determined whether the 2D point is located within a triangle of the 2D input mesh. If it is determined that the 2D point is located within a triangle of the 2D input mesh, the barycentric coordinate of that 2D point is computed, which is a weighted sum of the 2D input mesh vertices that adds up to the 2D position of the template vert. Subsequently, the same weights are obtained from the barycentric coordinate, and a weighted sum on the corresponding 3D points of the input mesh 3D verts is determined as the 3D position of the template vert.

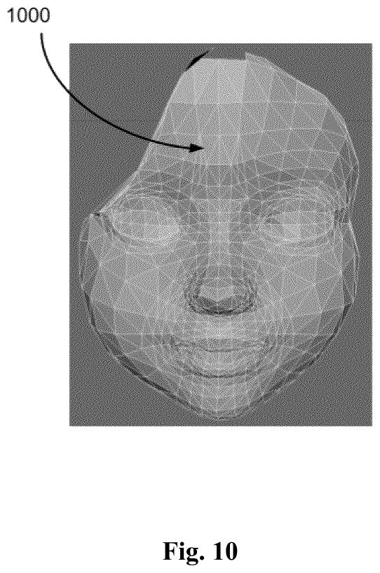

FIG. 10 depicts an example reinflation of a 2D parameterized mesh into a target 3D mesh of a virtual character, in accordance with some implementations.

As depicted in FIG. 10, the target 3D mesh of a virtual character 1000 has good topology while matching the geometry of the source 3D mesh.

In some implementations, subsequent to the reinflation of the 2D parameterized mesh into the target 3D mesh, selected portions (portions that were previously excluded) of the target 3D mesh may be filled in by performing a constrained fit. In some implementations, the constrained fit may be performed such that every point included in the target 3D mesh is exactly constrained and points corresponding to the selected portions are deformed from the template 3D mesh.

For example, the constrained fit may be performed for the neck, ears, eye bags, forehead, top of head etc., that were previously excluded (trimmed) from the second 3D mesh to generate a fitted target 3D mesh.

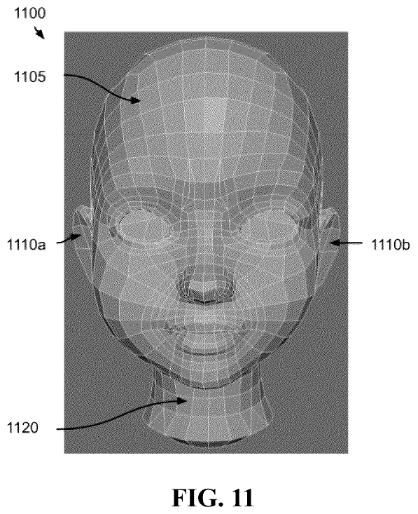

FIG. 11 depicts an example of constrained fitting of excluded portions of a face in a target 3D mesh of a virtual character, in accordance with some implementations.

As depicted in FIG. 11, fitted target 3D mesh 1100 includes features that were previously excluded such as forehead 1105, ears (1110a and 1110b), and neck 1120.

In some implementations, a radial basis function (RBF) based mesh deformation may be further performed to include disconnected parts in the fitted target 3D mesh to generate an augmented target 3D mesh. In some implementations, the augmented target 3D mesh may include the eyeballs, teeth, and/or tongue of a virtual avatar.

In some implementations, UV maps, skinning, and/or animation routines associated with the 3D template mesh may be transferred to any of the augmented target 3D mesh, fitted target 3D mesh, target 3D mesh, etc.

Block 450 may be followed by block 460.

At block 460, an animation of the virtual avatar may be generated based on the target 3D mesh (or optionally, the augmented target 3D mesh or the fitted target 3D mesh).

In some implementations, the animation may be generated by simulating motion of parts of the virtual avatar by simulating motion of points in the target 3D mesh that correspond to the parts of the virtual avatar. Block 460 may be followed by block 470.

At block 470, the generated animation may be displayed, e.g., on a display screen of a computing device. In some implementations, the generated animation may include a plurality of images of a face of a virtual avatar based on the target 3D mesh by transferring one or more of a UV texture map, skinning, and animation routine from the template 3D mesh to the target 3D mesh.

Method 400, or portions thereof, may be repeated any number of times using additional inputs. Blocks 410-470 may be performed (or repeated) in a different order than described above and/or one or more steps can be omitted. For example, blocks 460-470 may be omitted in some implementations. Blocks 410-470 may be performed at different rates. For example, blocks 440-450 may be performed multiple times with different template 3D meshes. Method 400 may also be utilized to generate 3D meshes of other portions of a virtual avatar. For example, a template 3D mesh of a torso of a virtual avatar may be utilized to generate a 3D mesh of a torso with good topology based on a received 3D mesh of a torso of a virtual avatar. Method 400 may be applied to a variety of other 3D objects, e.g., animals, humanoids, imaginary characters, etc. Additionally, blocks 410-450 may be repeated if it is determined that the virtual avatar has undergone changes in the virtual environment that may necessitate portions of the 3D mesh of a virtual avatar to be determined afresh.

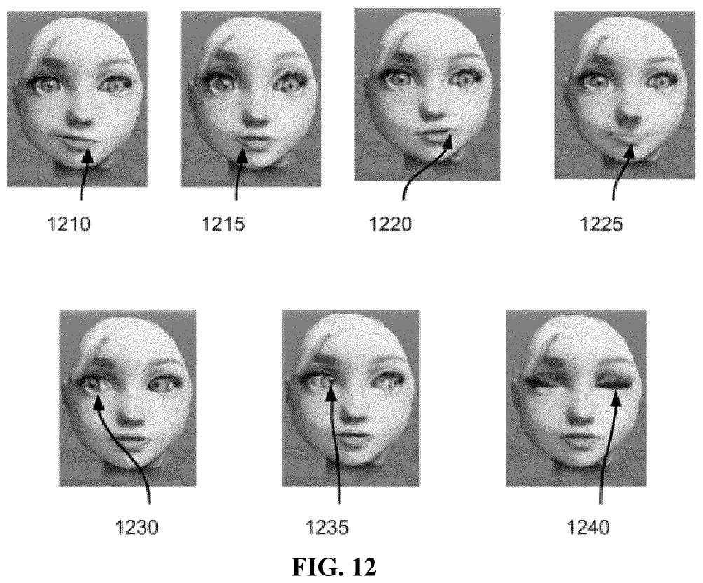

FIG. 12 depicts example images of an animated face in a virtual environment, in accordance with some implementations.

FIG. 12 depicts example frames of a virtual avatar rendered during animation that utilizes a target 3D mesh that is generated from a source 3D mesh.

In this illustrative example, animation via motion of the mouth is depicted in images 1210, 1215, 1220, and 1225. Specifically, an appearance of mouth movement in the virtual avatar is created by lateral movement of vertices associated with the mouth in the target 3D mesh.

Similarly, facial expression animation via eye movements is depicted in images 1230, 1235, and 1240.

In some implementations (not shown here), multiple portions of a virtual avatar may be animated simultaneously to create additional effects (for example, simultaneous movement of eyes and a mouth).

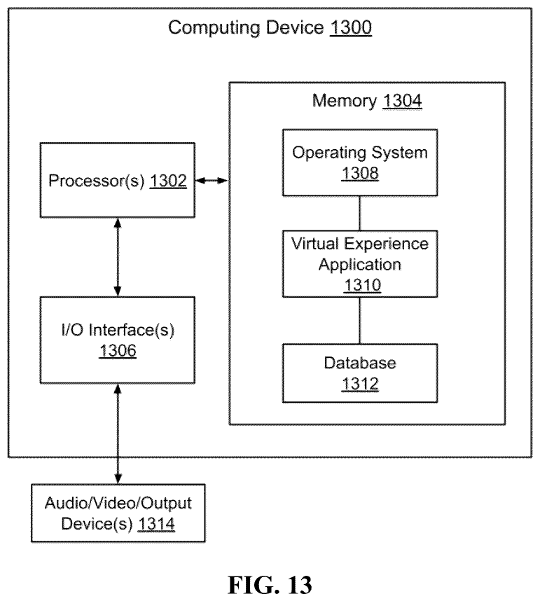

FIG. 13 illustrates an example computing device, in accordance with some implementations.

In one example, device 1300 may be used to implement a computer device (e.g. 102, 110, and/or 130 of FIG. 1), and perform suitable method implementations described herein. Computing device 1300 can be any suitable computer system, server, or other electronic or hardware device. For example, the computing device 1300 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1300 includes a processor 1302, a memory 1304, input/output (I/O) interface 1306, and audio/video input/output devices 1314.

Processor 1302 can be one or more processors, processing devices, and/or processing circuits to execute program code and control basic operations of the device 1300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1304 is typically provided in device 1300 for access by the processor 1302 and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1302 and/or integrated therewith. Memory 1304 can store software operating on the server device 1300 by the processor 1302, including an operating system 1308, one or more applications 1310, e.g., an audio spatialization application, a sound application, content management application, and application data 1312. In some implementations, application 1310 can include instructions that enable processor 1302 to perform the functions (or control the functions of) described herein, e.g., some or all of the methods described with respect to FIG. 4.

For example, applications 1310 can include an audio spatialization module which as described herein can provide audio spatialization within an online virtual experience server (e.g., 102). Any software in memory 1304 can alternatively be stored on any other suitable storage location or computer-readable medium. In addition, memory 1304 (and/or other connected storage device(s)) can store instructions and data used in the features described herein. Memory 1304 and any other type of storage (magnetic disk, optical disk, magnetic tape, or other tangible media) can be considered “storage” or “storage devices.”

I/O interface 1306 can provide functions to enable interfacing the server device 1300 with other systems and devices. For example, network communication devices, storage devices (e.g., memory and/or data store 120), and input/output devices can communicate via interface 1306. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1314 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 13 shows one block that is representative of each processor 1302, memory 1304, I/O interface 1306, and software blocks 1308 and 1310. These blocks may represent one or more processors, computing instances on distributed computing systems, processing devices, or processing circuitries, operating systems, memories, I/O interfaces, applications, and/or software engines. In other implementations, device 1300 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 1000, e.g., processor(s) 1002, memory 1004, and I/O interface 1006. An operating system, software and applications suitable for the user device can be provided in memory and used by the processor. The I/O interface for a user device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1014, for example, can be connected to (or included in) the device 1000 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 400, etc.) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a user device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
obtaining a source three-dimensional (3D) mesh of a face of an avatar, wherein the source 3D mesh includes a first plurality of polygons;
generating a second 3D mesh based on the source 3D mesh, wherein a count of polygons in the second 3D mesh is fewer than a count of polygons in the source 3D mesh;
determining a two-dimensional (2D) parameterization of the second 3D mesh;
determining a target 2D parameterization based on a template 3D mesh and the 2D parameterization of the second 3D mesh such that one or more landmarks identified in the source 3D mesh are aligned with corresponding landmarks on the template 3D mesh; and
reconstructing the target 2D parameterization into a target 3D mesh.

2. The computer-implemented method of claim 1, wherein generating the second 3D mesh comprises obtaining a trimmed 3D mesh by excluding particular portions of the source 3D mesh.

3. The computer-implemented method of claim 2, wherein the particular portions of the source 3D mesh are one or more of: portions of the source 3D mesh that correspond to hair of the face, portions of the source 3D mesh where an angle of a normal at the portions meets a threshold angle, portions of the source 3D mesh that lie at least a threshold distance from the one or more landmarks identified in the source 3D mesh, and combinations thereof.

4. The computer-implemented method of claim 2, further comprising prior to determining the target 2D parameterization based on the template 3D mesh, obtaining a trimmed template 3D mesh by excluding portions in the template 3D mesh that meet predetermined criteria, and wherein determining the target 2D parameterization is based on the trimmed template 3D mesh.

5. The computer-implemented method of claim 2, further comprising filling in the particular portions of the target 3D mesh by performing a constrained fit such that every point included in the target 3D mesh is exactly constrained and points corresponding to the particular portions are deformed from the template 3D mesh.

6. The computer-implemented method of claim 2, wherein determining the target 2D parameterization of the template 3D mesh comprises applying a least squares conformal map (LSCM) technique to points of the template 3D mesh that lie outside the particular portions of the source 3D mesh.

7. The computer-implemented method of claim 1, wherein determining the 2D parameterization of the second 3D mesh comprises applying a least squares conformal map (LSCM) technique to the second 3D mesh.

8. The computer-implemented method of claim 1, wherein the one or more landmarks identified in the source 3D mesh correspond to one or more of eyes, nose, and mouth.

9. The computer-implemented method of claim 1, further comprising simulating motion of parts of the face by simulating motion of points in the target 3D mesh that correspond to the parts of the face.

10. The computer-implemented method of claim 1, further comprising generating an image of the face based on the target 3D mesh by transferring one or more of a UV texture map, skinning, and animation routine from the template 3D mesh to the target 3D mesh.

11. A non-transitory computer-readable medium with instructions stored thereon that, responsive to execution by a processing device, cause the processing device to perform operations comprising:
obtaining a source three-dimensional (3D) mesh of a face of an avatar, wherein the source 3D mesh includes a first plurality of polygons;
generating a second 3D mesh based on the source 3D mesh, wherein a count of polygons in the second 3D mesh is fewer than a count of polygons in the source 3D mesh;
determining a two-dimensional (2D) parameterization of the second 3D mesh;
determining a target 2D parameterization based on a template 3D mesh and the 2D parameterization of the second 3D mesh such that one or more landmarks identified in the source 3D mesh are aligned with corresponding landmarks on the template 3D mesh; and
reconstructing the target 2D parameterization into a target 3D mesh.

12. The non-transitory computer-readable medium of claim 11, wherein generating the second 3D mesh comprises obtaining a trimmed 3D mesh by excluding particular portions of the source 3D mesh.

13. The non-transitory computer-readable medium of claim 12, wherein the particular portions of the source 3D mesh are one or more of: portions of the source 3D mesh that correspond to hair of the face, portions of the source 3D mesh where an angle of a normal at the portions meets a threshold angle, portions of the source 3D mesh that lie at least a threshold distance from the one or more landmarks identified in the source 3D mesh, and combinations thereof.

14. The non-transitory computer-readable medium of claim 12, wherein the operations further comprise prior to determining the target 2D parameterization based on the template 3D mesh, obtaining a trimmed template 3D mesh by excluding portions in the template 3D mesh that meet a predetermined criteria, and wherein determining the target 2D parameterization is based on the trimmed template 3D mesh.

15. The non-transitory computer-readable medium of claim 12, wherein the operations further comprise filling in the particular portions of the target 3D mesh by performing a constrained fit such that every point included in the target 3D mesh is exactly constrained and points corresponding to the particular portions are deformed from the template 3D mesh.

16. The non-transitory computer-readable medium of claim 12, wherein determining the target 2D parameterization of the template 3D mesh further comprises applying a least squares conformal map (LSCM) technique to points of the template 3D mesh that lie outside the particular portions of the source 3D mesh.

17. A system comprising:
a memory with instructions stored thereon; and
a processing device, coupled to the memory, the processing device configured to access the memory and execute the instructions, wherein the instructions cause the processing device to perform operations comprising:
obtaining a source three-dimensional (3D) mesh of a face of an avatar, wherein the source 3D mesh includes a first plurality of polygons;
generating a second 3D mesh based on the source 3D mesh, wherein a count of polygons in the second 3D mesh is fewer than a count of polygons in the source 3D mesh;
determining a two-dimensional (2D) parameterization of the second 3D mesh;
determining a target 2D parameterization based on a template 3D mesh and the 2D parameterization of the second 3D mesh such that one or more landmarks identified in the source 3D mesh are aligned with corresponding landmarks on the template 3D mesh; and
reconstructing the target 2D parameterization into a target 3D mesh.

18. The system of claim 17, wherein the one or more landmarks identified in the source 3D mesh correspond to one or more of eyes, nose, and mouth.

19. The system of claim 17, wherein the operations further comprise simulating motion of parts of the face by simulating motion of points in the target 3D mesh that correspond to the parts of the face.

20. The system of claim 17, wherein the operations further comprise generating an image of the face based on the target 3D mesh by transferring one or more of a UV texture map, skinning, and animation routine from the template 3D mesh to the target 3D mesh.
